(19) United States
(12) Patent Application Publication
(10) Pub. No.: US 2010/0085265 A1
(43) Pub. Date: Apr. 8, 2010

(54) ARRAY FOR INFLUENCING THE RADIATION CHARACTERISTICS OF A REFLECTOR ANTENNA, PARTICULARLY A CENTRALLY FOCUSED REFLECTOR ANTENNA

(76) Inventors: Frank Woetzel, Leipzig (DE); Mario Nowack, Schkeuditz (DE)

Correspondence Address: COLLARD & ROE, P.C., 1077 NORTHERN BOULEVARD, ROSLYN, NY, 11576, US

(21) Appl. No.: 12/449,530

(22) PCT Filed: Feb. 13, 2008
(86) PCT No.: PCT/DE2008/000284

§ 371 Date: Sep. 28, 2009

(30) Foreign Application Priority Data
Feb. 13, 2007 (DE) 10 2007 007 707.8

(51) Int. Cl. H01Q 13/00

(52) U.S. Cl. 343/781 CA; 343/876

(57) ABSTRACT

The invention relates to an array for influencing the radiation characteristics of a reflector antenna, particularly a centrally focused reflector antenna (1) consisting of a hollow conductor (3) with a horn (4) and a sub-reflector component (2), whereby the assembly consists of at least two immoveable triggerable radiator elements (5; 6; 7; 8), which influence the beam path between the reflector (9) and sub-reflector (10) in the operating state. The array has the advantage of providing a small-size technical solution which requires minimal mechanical and electrical efforts for reflector antennas and allows the antenna to track a satellite with high accuracy. Within certain limits, signal reception and the antenna diagram can be controlled such that reception and transmission can be simultaneous. The beam of diagram can be controlled in real time.

Another advantage is that the hemisphere can be reproduced in full, i.e. at an angle of elevation ranging from 0° to 180° and an azimuthal angle ranging from 0° to 360°. The array can be used in previously known reflector antennas, is tolerant towards the ambient temperature, humidity, and vibrations and is inexpensive to produce since it requires a small number of control elements.

The invention is for an improved array for influencing the beam characteristics of a reflector antenna, particularly for a centrally-focused reflector antenna.

The array serves above all the purpose of being able to repeatedly adjust the beam characteristics of such an antenna with the aid of control signals so that the invention is also suitable for adjustment of an antenna.

It is known that for excitation of a centrally-focused reflector antenna system or for beam control either a grooved horn or a flattened hollow conductor has to be located on the end of the hollow conductor as an excitation system.

The excitation system is then placed in the focus, the phase centre of the reflector antenna and should optimally illuminate this. Of particular importance in this case is the, for the most part, equal illumination of the reflector with a consistent configuration of the phases.

The known technical solutions to this problem are, however, all confounded by the fact that the functionality of the groove excitation system or the flattened hollow conductor cannot achieve an optimal field distribution in the reflector system or an optimal illumination.

In addition, the know excitation systems cannot be combined with subsequent components, for instance down converters, without reactions. It is therefore generally required that additional efforts be taken to optimally adjust such a known excitation system to the subsequent component with the associated costs.

The associated problems are to be rectified with the technical solution provided by EP 1 384 287 B1.

The EP 1 384 287 B1 describes an array for the excitation of a centrally-focused reflectors antenna with a hollow conductor and a dielectric medium, whereby a dielectric field transformer is attached to the hollow conductor and the dielectric medium is attached in front of the hollow conductor near the dielectric field transformer without being mechanically or electrically attached to this. The dielectric medium has a circular bore in its middle the diameter of which corresponds to the diameter of the dielectric field transformer. In this arrangement the dielectric field transformer partially protrudes into the circular bore. A mounting platform for the subsequent components is located on the end of the hollow conductor.

This array completely fulfils its function to the extent that the reflector antenna is used for the reception of satellite signals. It guarantees an optimal field and broadband excitation of the centrally-focused reflector antenna in their focus without mechanically movable components and can also be manufactured at low costs. The array does, however, require a field transformer. An antenna with this array is not suited for broadcasting signals. In addition, this type of antenna is also not suited for double-focused reflector antennas as used for transmitting via satellites, amongst other things because of the much greater bandwidth.

The task of the invention is therefore to provide an improved array for influencing the beam characteristics of a reflector antenna, in particular of a centrally-focused reflector antenna, which reproducibly changes the beam characteristics of the antenna by means of control signal for smaller types and those without field transformers so that the array is suited for adjustment of antennas and antennas with this array can be used to receive signals from satellites and/or to transmit such signals to satellites.

The invention accomplishes the task with an array for influencing the beam characteristics of a reflector antenna, particularly a centrally-focused reflector antenna with a hollow conductor, a horn and a sub-reflector component so that the array has at least two immobile triggerable radiator elements which influence the path of the beam between the reflector and the sub-reflector when turned on.

With the invented array there is the advantage that in a small distance a technical solution with the least amount of mechanical and electrical effort is provided for reflector antennas, especially those on moveable platforms, allow for the adjustment of antennas to a satellite with greater precision. Both the reception of signals, for instance the reception of TV signals, as well as the antenna diagram can be controlled to a certain degree so that the parallel operation of reception and transmission can be performed simultaneously. The beam or diagram control is possible in real-time. While reception is limited to a certain spectral range, the range for transmission is not influenced or only to a very small degree.

An additional advantage of the invented technical solution compared to the state of the art technology is that the hemisphere can be completely reproduced from 0° to 180° in the elevation and from 0° to 360° in the azimuth.

The invented array can be used in known reflector antennas. Beyond that it is environmentally tolerable to temperature, humidity and vibration and, with a small number of control elements, is also inexpensive to produce.

An advantageous construction of the array foresees the radiator elements located on the horn or on the sub-reflector component, preferably on the horn.

The preferred forms for the array has four radiator elements which are located concentrically on the horn whereby the radiator elements are such elements that are suitable for generating an interaction with an alternating electromagnetic field and are preferably dipolar, monopolar or active components such as tunnel diodes.

Other advantages of the inventions construction foresee the radiator elements located on a dielectric medium and that they have a resonance frequency which is within the reception frequency range of the reflector antenna and that the radiator elements are can be controlled sequentially, individually or in groups.

In a preferred form of construction of the invention the control of the radiator elements occurs in a frequency range that is different from the frequency range of the reflector antenna.

And finally, an additional form of construction of the array foresees that the radiator elements have control cables which are magnetically and electrically shielded and protected against mechanical influences.

A further construction of the invention is the location of the radiator elements on an attachment cross in their axes based on the center of the horn 45 degrees to the axis of the polarization cross.

In another form of the invention the radiator elements are connected with a controllable active or passive control element, preferably by means of a switch diode.

The following is intended to explain the invention and its functionality on the basis of illustrations. They show

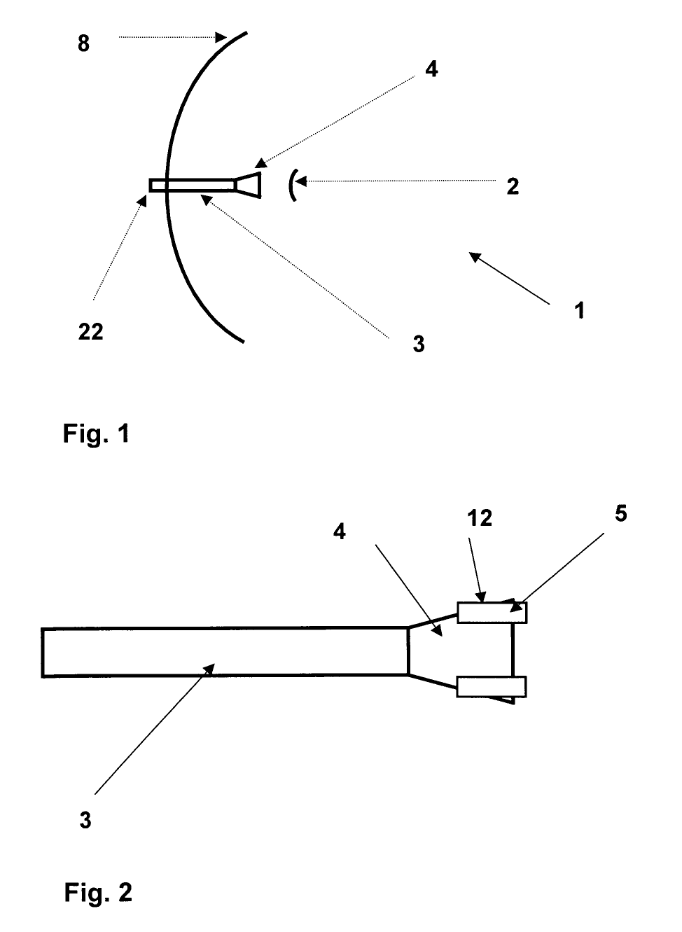

FIG. 1 Schematic drawing of a double and centrally-focused reflector antenna

FIG. 2 Schematic drawing of the array of elements on the horn

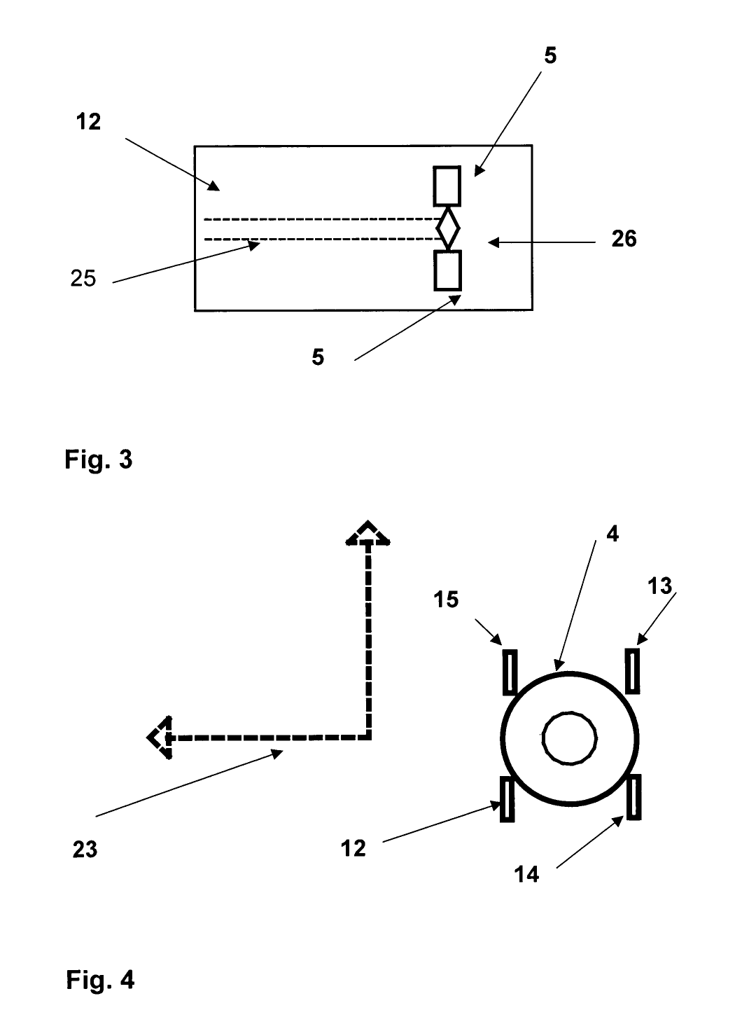

FIG. 3 Schematic drawing of a radiator element with control cables on a dielectric medium

FIG. 4 Schematic drawing of the front view of the exciting horn with radiator elements (seen from the perspective of the sub-reflector) with the associated view of the polarization cross

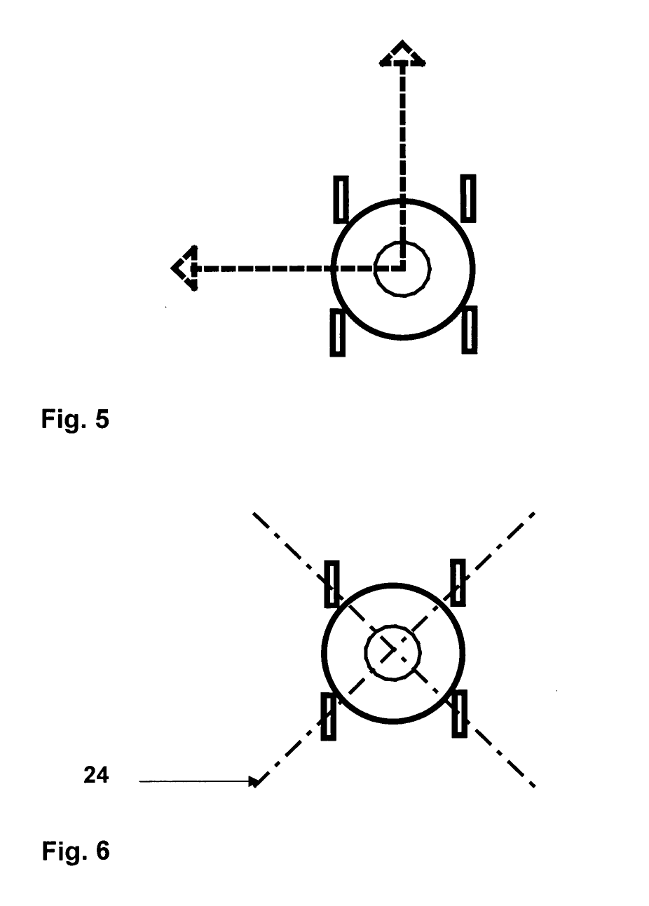

FIG. 5 Same presentation and view as FIG. 4 but with the inclusion of the polarization cross in the centre of the horn

FIG. 6 Same presentation as FIG. 4 and FIG. 5 but with the presentation of the attachment cross for the radiator elements and support elements

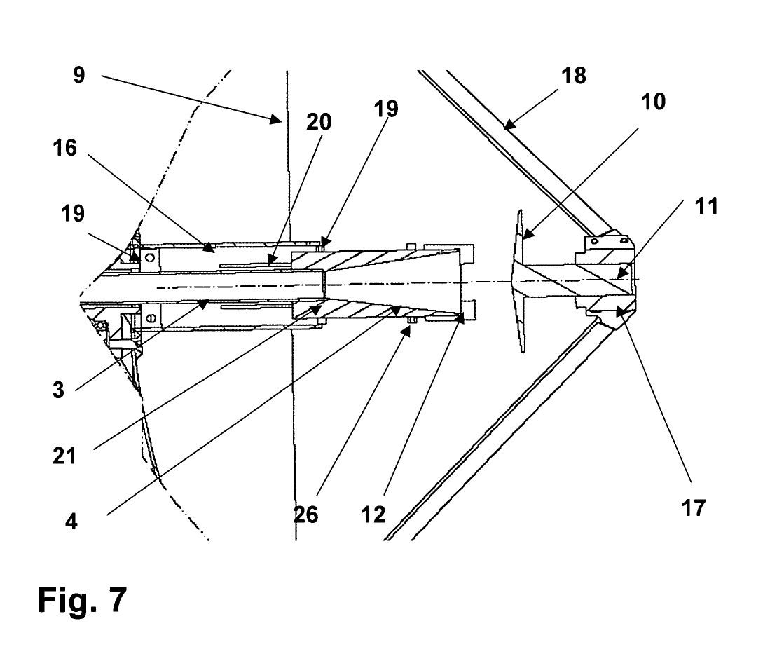

FIG. 7 Constructive cross-section through a part of the reflector antenna-array

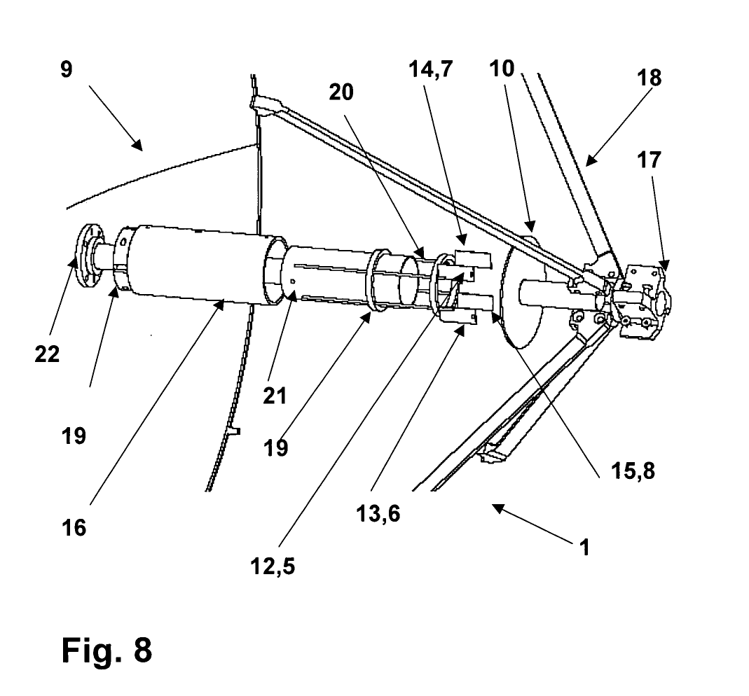

FIG. 8 Constructive presentation through a part of the array shown as exploded view

FIG. 1 shows the basic construction of a reflector antenna. It shows a double-focused, centrally excited reflector antenna (1). The components have been presented schematically. The antenna consists of a reflector (8) which is excited by means of a horn (4) and a sub-reflector (2). The horn (4) is fed by means of a hollow conductor (3). At the end of the hollow conductor (3) there is an attachment (22) for mounting additional components.

FIG. 2 shows a schematic side view of the hollow conductor (3) from FIG. 1 with the horn (4). It should show that the radiator elements (5; 6; 7; 8) are arrayed on dielectric media (12; 13; 14; 15) on the side of the horn (4) and protrude slightly beyond the edge of the horn (4). The radiator elements (5) presented here are on the end of the dielectric medium (11) and protrude beyond the opening of the horn.

In FIG. 3 shows the principle array of the radiator elements (5) on the dielectric medium (11). Here the radiator elements (5) are, for instance, executed dipolar and connected by means of a triggerable switching component. Here the control cable (25) is presented schematically and is connected with an active or passive control element (26). In the sample construction these control cables (25) are connected from the dielectric medium (12) to the subsequent components through a guide in a thin metal tube (20), which is electrically and magnetically shielded. The metal tube (20) is attached to the dielectric medium (11) on the side away from the radiator element (5). This is realized simultaneously by a number of functions, the shielding of the control cables (25) in the direction of the subsequent components, the mechanical attachment of the control cables (25), the mechanical attachment of the dielectric medium (12) and by the possibility of attaching it to the horn (4).

FIG. 4 shows an example of the arrangement of the polarization cross (23) for linear polarisation based on the array of the radiator elements (5; 6; 7, 8). Here it is not important how the axes of the horizontal and vertical polarisation are assigned. It is to be assumed that the axes are placed orthogonal to one another.

In FIG. 5 the polarisation cross is projected into the middle axis of the horn (4). For the sake of better presentation the attachment cross of the radiator and support elements (24) are not shown in FIG. 5 but separately in FIG. 6. From FIG. 5 and FIG. 6 it is clear that both crosses are related in their angle to the middle axis of the horns (4) and turned 45 degrees. All the necessary support elements (18) are in the plane shown in FIG. 6 as can be seen clearly in FIG. 8.

FIG. 7 shows a segment of an sample construction of the antenna (1). The support elements (18)—4 units in the sample—as well as the entire hollow conductor construction for exciting the sub-reflector (10) consisting of a hollow conductor (3), a metal cylinder (21) which is attached to the hollow conductor (3) and in the exciting horn (4) are attached to the reflector (9). The mounting rings (19) are, in turn, attached to the hollow conductor (3) and the cylinder (21) and hold the thin metal tube (20), containing the control cables. The hollow conductor (3) and the elements connected to it are protected by a metal tube (16), which is also attached to the mounting rings (19). The cross-section also shows how the sub-reflector (10) with its holder (11) is connected with the support elements (18) with the multi-functional holder (17).

FIG. 8 shows an exploded view of the invented array in the reflector antenna (1). It clearly shows how the dielectric media (12; 13; 14; 15) are connected to the radiator elements (5; 6; 7; 8) with the thin metal tubes (20) and these, in turn, with the mounting rings (19) and the rings are attached to the metal cylinder (21) and the hollow conductor (3). The array is protected by a metal tube (16). At the end of the hollow conductor (3) there is a connector (22) for subsequent components. In addition, the illustration shows the support elements (18) and the multifunctional holder (17) and the sub-reflector (10).

### REFERENCE LIST

1 Reflector antenna
2 Sub reflector with mounting
3 Hollow conductor
4 horn
5 Radiator element
6 Radiator element
7 Radiator element
8 Radiator element
9 Reflector
10 Sub reflector
11 Sub-reflector holder
12 Dielectric medium
13 Dielectric medium
14 Dielectric medium
15 Dielectric medium
16 Metal tube
17 Multifunctional holder
18 Support element
19 Mounting ring
20 Thin metal tube
21 Metal cylinder
22 Connection for subsequent components (HL flange)
23 Polarisation cross for linear polarisation
24 Attachment cross for radiator elements and support elements
25 Control cables
26 Passive or active control element
27 Mounting of the dielectric medium

1. Array for the influencing of the radiation characteristics of a centrally focused reflector antenna (1) with a hollow conductor (3) with a horn (4), a sub-reflector sub-assembly (2), comprising the arrangement of at least two triggerable radiator elements (5; 6; 7; 8), which are rigidly attached to the horn (4) and when switched on influence the beam between the reflector (9) and sub-reflector (10).

2. (canceled)

3. Arrangement as per claim 1, further comprising the placement of four radiator elements (5; 6; 7; 8), which are arranged concentrically on the horn (4).

4. Arrangement as per claim 1, further comprising the radiator elements (5; 6; 7; 8) being elements which are suited for generating an interaction with an alternating electromagnetic field and which is preferably dipolar, monopolar or active components such as tunnel diodes.

5. Arrangement as per claim 1, further comprising the radiator elements (5; 6; 7; 8) are arranged on a dielectrical element (12; 13; 14: 15).

6. Arrangement as per claim 1, further comprising the radiator elements (5; 6; 7; 8) having a resonance frequency which is within the reception frequency range of the reflector antenna (1).

7. Arrangement as per claim 1, further comprising the radiator elements (5; 6; 7; 8) being triggerable sequentially, individually or in groups.

8. Arrangement as per claim 1, further comprising the activation of the radiator elements (5; 6; 7; 8) being in a frequency range which is different than the utilizable frequency range of the reflector antenna (1).

9. Arrangement as per claim 1, further comprising the radiator elements (5; 6; 7; 8) having control cables (25) which are magnetically and electrically shielded and protected from magnetic influences.

10. Arrangement as per claim 1, further comprising the radiator elements (5; 6; 7, 8) arranged with their axes to the arrangement cross (24), based on the centre of the horn, by 45 degrees to the axis of the polarisation cross (23).

11. Arrangement as per claim 1, further comprising the radiator elements (5) linked together with a triggerable active or passive control element (26), preferably by means of a switching diode.
